(19) United States
(12) Patent Application Publication
(10) Pub. No.: US 2013/0108530 A1
(43) Pub. Date: May 2, 2013

(54) PROCESS FOR PRODUCING CERIA-ZIRCONIA-ALUMINA COMPOSITE OXIDES AND APPLICATIONS THEREOF

(71) Applicants: Hsiao-Lan Chang, Berwyn, PA (US); Scott Daniel Cauffman, Eagleville, PA (US); Haiying Chen, Conshohocken, PA (US); Paul Joseph Andersen, Plymouth Meeting, PA (US)

(72) Inventors: Hsiao-Lan Chang, Berwyn, PA (US); Scott Daniel Cauffman, Eagleville, PA (US); Haiying Chen, Conshohocken, PA (US); Paul Joseph Andersen, Plymouth Meeting, PA (US)

(73) Assignee: JOHNSON MATTHEY PUBLIC LIMITED COMPANY, London (GB)

(21) Appl. No.: 13/283,123

(22) Filed: Oct. 27, 2011

(51) Int. Cl. B01J 21/06; B01D 53/94

(52) U.S. Cl. 423/213.5; 502/439; 502/304

(57) ABSTRACT

A process for producing a ceria-zirconia-alumina composite oxide is disclosed. The process comprises combining a cerium (IV) compound and a zirconium (IV) compound with a slurry of aluminum oxide at a temperature greater than 40° C. to produce a reaction slurry, then contacting the reaction slurry with a precipitating agent to precipitate insoluble cerium and zirconium compounds onto the aluminum oxide and form cerium-zirconium-aluminum oxide particles, and calcining the cerium-zirconium-aluminum oxide particles to produce a ceria-zirconia-alumina composite oxide. The process to produce ceria-zirconia-alumina composite oxides provides a material having a high oxygen storage/release capacity that is suitable for a catalyst with enhanced cleaning of the exhaust gases from internal combustion engines.

### FIELD OF THE INVENTION

The invention relates to a process for producing ceria-zirconia-alumina composite oxides, and applications of the composite oxides produced by the process of the invention.

### BACKGROUND OF THE INVENTION

Internal combustion engines produce exhaust gases containing a variety of pollutants, including hydrocarbons, carbon monoxide, and nitrogen oxides. Many different techniques have been applied to exhaust systems to clean the exhaust gas before it passes to atmosphere. The most commonly used catalyst for automobile applications is the “three-way catalyst” (TWC). TWCs perform three main functions: (1) oxidation of CO; (2) oxidation of unburnt hydrocarbons; and (3) reduction of NOₓ to N₂.

TWCs require careful engine management techniques to ensure that the engine operates at or close to stoichiometric conditions (air/fuel ratio, λ=1). However, it is necessary for engines to operate at non-stoichiometric conditions at various stages during an operating cycle. When the engine is running rich (λ<1), for example during acceleration, it is more difficult to carry out oxidation reactions on the catalyst surface due to the reducing nature of the exhaust gas composition. As a result, TWC's have been developed to incorporate a component which stores oxygen during leaner periods (λ>1) of the operating cycle, and releases oxygen during richer periods in order to extent the effective operating envelope.

Cerium-zirconium composite oxides are widely used as oxygen storage components (OSC's) in three-way catalysts, and are also key components in many environmental catalysts, due to their unique oxygen storage/release property and good hydrothermal stability. However, severe sintering of cerium-zirconium mixed oxides may still occur when they are exposed to elevated temperatures, which typically also leads to a significant decrease in their oxygen storage capacity. To further improve the thermal stability, composite oxides of cerium-zirconium with additional elements have been studied.

Incorporation of alumina into cerium-zirconium oxides has been reported as a mean to improve the thermal resistance and to enhance the oxygen storage/release property of the materials. In Japanese Kokai No. 7-300315, cerium-zirconium salt precursors were impregnated onto alumina oxides. In U.S. Pat. No. 5,883,037, cerium-zirconium hydroxides were precipitated then mixed with alumina to form mixtures. In U.S. Pat. Nos. 6,306,794 and 6,150,288, and PCT Intl. Appl. WO 2006/070201, homogeneous aluminium-cerium-zirconium composite oxides prepared by co-precipitation of cerium/zirconium/aluminium salt precursors as described. In U.S. Appl. Pub. No. 2007/0191220 A1, materials with a surface coat of alumina on cerium-zirconium oxides were described. In U.S. Appl. Pub. No. 2011/0171092 A1, a cerium-zirconium composite oxide is ball-milled together with γ-alumina powder, zirconia powder, and water containing platinum and rhodium compounds to produce a slurry that is then coated on a flow-through monolith to produce an exhaust gas purification catalyst.

It is desirable to attain still further improvements in the production of ceria-zirconia-alumina composite oxides as well as their use in exhaust gas treatment systems. We have discovered a new process to produce ceria-zirconia-alumina composite oxides that provides a material with enhanced oxygen storage/release capacity for cleaning of the exhaust gases from internal combustion engines.

### SUMMARY OF THE INVENTION

The invention includes a process to produce ceria-zirconia-alumina composite oxides and the application of the materials. The process comprises combining a cerium (IV) compound and a zirconium (IV) compound with a slurry of aluminum oxide at a temperature greater than 40° C. to produce a reaction slurry, then contacting the reaction slurry with a precipitating agent to precipitate insoluble cerium and zirconium compounds onto the aluminum oxide to form cerium-zirconium-aluminum oxide particles, and calcining the cerium-zirconium-aluminum oxide particles to produce the ceria-zirconia-alumina composite oxide. The ceria-zirconia-alumina composite oxide is utilized as a component on TWC and exhibits improved, CO, NOₓ, and hydrocarbon conversion.

### DETAILED DESCRIPTION OF THE INVENTION

The invention is a process for producing a ceria-zirconia-alumina composite oxide. The process comprises first combining a cerium (IV) compound and a zirconium (IV) compound with a slurry of aluminum oxide at a temperature greater than 40° C. to produce a reaction slurry.

Although the process of the invention is not limited by choice of a particular cerium (IV) compounds, suitable cerium (IV) compounds useful in the invention include, but are not limited to, cerium (IV) nitrates, ammonium nitrates, sulfates, ammonium sulfates, alkoxides (e.g., isopropoxides), and mixtures thereof. Preferred cerium (IV) compounds include cerium (IV) nitrate and cerium (IV) ammonium nitrate.

Suitable zirconium (IV) compounds include, but are not limited to, zirconium (IV) carboxylates (e.g., acetate, citrate), halides (e.g., chlorides, bromides), oxyhalides (e.g., oxychloride), carbonates, nitrates, oxynitrate, sulfates, and mixtures thereof. Preferred zirconium (IV) compounds include zirconium (IV) oxynitrate and zirconium (IV) oxychloride.

Suitable aluminum oxides useful in the practice of the invention are solid oxides that contain a major proportion of alumina (Al₂O₃), and preferably are porous, in that they have numerous pores, voids, or interstices throughout their structures. In general, suitable aluminum oxides are further characterized by having a relatively large surface area in relation to their mass. The term used herein and one normally used in the art to express the relationship of surface area to mass is “specific surface area”. The aluminum oxides for purpose of this invention preferably have a specific surface area of at least 10 m²/g, and more preferably from 50 m²/g to 500 m²/g, and most preferably from 80 m²/g to 300 m²/g.

Preferred aluminum oxides include various forms of alumina including well known aluminas such as α-aluminas, θ-aluminas, ζ-aluminas, γ-aluminas, and activated aluminas. Activated aluminas are partially hydroxylated aluminum oxide whose chemical compositions can be represented by the formula Al₂O₍₃₋ₓ₎(OH)₂ₓ, where x ranges from about 0 to 0.8.

The aluminum oxide preferably has an average particle size greater than 0.05 μm (micron), more preferably from about 0.11 μm to about 400 μm, and most preferably greater than 1 μm, especially from 1 μm to about 40 μm.

Preferably, the pore volume of the aluminum oxide is in the range of about 0.1 to about 4.0 mL/g, more preferably from about 0.1 to about 2.0 mL/g, and most preferably from about 0.1 to about 1.0 mL/g. The average pore diameter is typically in the range of about 10 to about 1000 Å, preferably about 20 to about 500 Å, and most preferably about 50 to about 350 Å.

Preferably, the aluminum oxide is a rare earth or alkaline earth-stabilized aluminum oxide, and more preferably the rare earth or alkaline earth-stabilized aluminum oxide contains a rare earth or alkaline earth metal selected from the group consisting of lanthanum, neodymium, praseodymium, yttrium, barium, and strontium. Preferably, the rare earth or alkaline earth-stabilized aluminum oxide comprises from 0.1 to 20 weight percent rare earth or alkaline earth metal. The combination of cerium and zirconium compounds with the aluminum oxide slurry to produce a reaction slurry may be by any convenient method. Preferably, a slurry of aluminum oxide is first formed by adding the aluminum oxide to a solvent. The solvent is preferably water. The aluminum oxide slurry preferably contains between 0.1 to 50 weight percent aluminum oxide, more preferably between 1 to 20 weight percent. The slurry is then heated to a temperature greater than 40° C., preferably greater than 50° C. and most preferably at a temperature from 60° C. to 100° C., and then the cerium (IV) compound and the zirconium (IV) compound are added. The order of addition of the cerium and zirconium is not particularly critical, so that the cerium may be added first, the zirconium may be added first, or the cerium and zirconium compounds may be added simultaneously.

Optionally, a rare earth or transition metal compound may also be combined with the cerium compound, zirconium compound and the aluminum oxide slurry to form the reaction slurry. The rare earth or transition metal compound may be added to the aluminum slurry prior to heating to a temperature greater than 40° C., prior to or following addition of the cerium (IV) compound and/or zirconium (IV) compound, or simultaneously with the added with the cerium (IV) compound and/or zirconium (IV) compound. The rare earth metal is preferably selected from the group consisting of lanthanum, neodymium, praseodymium and yttrium compounds. The transition metal is preferably selected from the group consisting of iron, manganese, cobalt and copper compounds. Preferably, the rare earth metal or transition metal compound is added such that the molar ratio of rare earth or transition metal:cerium and zirconium ((moles of rare earth or transition metal)/(moles of cerium+moles of zirconium)) in the reaction slurry ranges from 0.001 to 10. Generally, the process used to prepare ceria-zirconia-alumina composite oxides involves forming a reaction mixture wherein the weight ratios of slurry additives (as defined in terms of weight percent of ceria, weight percent of zirconia, and weight percent of Al₂O₃) preferably comprise the following weight ratios: CeO₂:ZrO₂:Al₂O₃=0.1-70:0.1-70:95-10, more preferably 5-60:5-60:90-20. The molar ratio of Ce:Zr is preferably within the range of 0.05 to 19, and more preferably is from 0.25 to 1.5.

Following formation of the reaction slurry, the reaction slurry is contacted with a precipitating agent to precipitate insoluble cerium and zirconium species onto the aluminum oxide and form cerium-zirconium-aluminum oxide particles.

The precipitating agent is any compound that is capable of precipitating a soluble cerium (IV) compound and a soluble zirconium (IV) compound out of an aqueous solution. The precipitating agent is typically a basic compound, and may be selected from any suitable basic material, preferably such as alkali and alkaline earth metal carbonates, ammonium and alkylammonium carbonates, ammonium and alkylammonium hydroxides, alkali and alkaline earth metal hydroxides, water-soluble organic base compounds, and mixtures thereof. The precipitating agent is preferably ammonium hydroxide or sodium hydroxide.

After formation by the precipitation step, the cerium-zirconium-aluminum oxide particles are preferably isolated by using techniques well known in the art. These include filtration, decantation, evaporation, washing, drying, and spray-drying, preferably one or more of filtration, washing, or spray-drying. Preferably, the cerium-zirconium-aluminum oxide particles are filtered and then washed with water or another solvent to isolate the particles prior to calcination. In another embodiment, the cerium-zirconium-aluminum oxide particles subjected to spray-drying (or rapid drying) to form microspheres of particle size. By submitting the slurry mixture to rapid drying, water is eliminated and simultaneously the cerium-zirconium-aluminum oxide is activated, leading to the formation of microspheres. The resulting microspheres typically have a particle size from 5 to 100 microns.

The cerium-zirconium aluminum oxide particles are finally calcined to produce a ceria-zirconia-alumina composite oxide product. The calcination is typically performed by heating the cerium-zirconium-aluminum oxide particles, preferably under an oxidizing atmosphere such as air or a nitrogen/oxygen mixture, at an elevated temperature. The preferred temperature range for calcination is in the range of from 400 to 1000° C. Typically, calcination times of from about 0.5 to 24 hours will be sufficient to render the ceria-zirconia-alumina composite oxide product.

The invention also includes the ceria-zirconia-alumina composite oxide produced by the process of the invention, and a three-way catalyst comprising one or more platinum group metals and the ceria-zirconia-alumina composite oxide. The platinum group metal (PGM) is preferably platinum, palladium, rhodium, or mixtures thereof; platinum, rhodium, and mixtures thereof are particularly preferred. Suitable loadings of PGM are 0.04 to 7.1 g/liter (1 to 200 g/ft³) catalyst volume.

The three-way catalyst is preferably coated on a substrate. The substrate is preferably a ceramic substrate or a metallic substrate. The ceramic substrate may be made of any suitable refractory material, e.g., alumina, silica, titania, ceria, zirconia, magnesia, zeolites, silicon nitride, silicon carbide, zirconium silicates, magnesium silicates, aluminosilicates and metallo aluminosilicates (such as cordierite and spudomene), or a mixture or mixed oxide of any two or more thereof. Cordierite, a magnesium aluminosilicate, and silicon carbide are particularly preferred.

The metallic substrate may be made of any suitable metal, and in particular heat-resistant metals and metal alloys such as titanium and stainless steel as well as ferritic alloys containing iron, nickel, chromium, and/or aluminum in addition to other trace metals.

The substrate may be a filter substrate or a flow-through substrate, and is most preferably a flow-through substrate, especially a honeycomb monolith. The substrate is typically designed to provide a number of channels through which vehicle exhaust passes. The surface of the channels is loaded with the catalyst.

The three-way catalyst may be added to the substrate by any known means. For example, the composite oxide or the PGM-containing composite oxide catalyst may be applied and bonded to the substrate as a washcoat, a porous, high surface area layer bonded to the surface of the substrate. The washcoat is typically applied to the substrate from a water-based slurry, then dried and calcined at high temperature. If only the composite oxide is washcoated on the substrate, the PGM metal may be loaded onto the dried washcoat support layer (by impregnation, ion-exchange, or the like), then dried and calcined.

The invention also encompasses treating an exhaust gas from an internal combustion engine, in particular for treating exhaust gas from a gasoline engine. The method comprises contacting the exhaust gas with the three-way catalyst of the invention.

The following examples merely illustrate the invention. Those skilled in the art will recognize many variations that are within the spirit of the invention and scope of the claims.

### Example 1

### Preparation of Ce—Zr—Al Composite Oxides

Catalyst 1A:

A slurry of La-doped γ-alumina (22.5 kg, containing 4% La₂O₃, d50=20 μm) in distilled water (495 kg) is heated to 70° C., followed by addition of aqueous cerium (IV) nitrate solution (37.2 kg, 16.3 wt. % Ce), aqueous zirconium oxynitrate solution (27.0 kg, 14.6 wt. % Zr), and aqueous ammonium hydroxide solution (31 kg, 29 wt. % NH₄OH). The reaction mixture is heated for 1 hour at 70° C., while the pH is maintained above 8, then filtered and washed with distilled water. The wetcake filtrate is dried in a static oven at 110° C. for 12 hours in air, then calcined in air at 500° C. for 4 hours to obtain Catalyst 1A. Catalyst 1A contains 21 wt. % CeO₂ and 15 wt. % ZrO₂.

Catalyst 1B:

Catalyst 1B is prepared according to the procedure of Catalyst 1A, with the exception that colloidal boehmite containing 4% La₂O₃ (3.23 kg, d50=70 nm) is used in place of La-doped γ-alumina, and is slurried in 70 kg distilled water, 5.30 kg of the cerium(IV) nitrate solution, 3.86 kg of the zirconium oxynitrate solution, and 4.5 kg ammonium hydroxide solution is used to produce Catalyst 1B. Catalyst 1B contains 21 wt. % CeO₂ and 15 wt. % ZrO₂.

### Comparative Example 2

### Preparation of Physical Mixture of Alumina and Ce—Zr Oxide

Comparative Catalyst 2:

A physical mixture of CeZr oxide and Al₂O₃ oxide is prepared by blending a γ-alumina containing 4% La₂O₃ with a cerium-zirconium composite oxide produced by combining aqueous cerium(IV) nitrate solution (18.2 kg, 7.7 wt. % Ce), aqueous zirconium oxynitrate solution (6.3 kg, 14.8 wt. % Zr), and aqueous ammonium hydroxide solution (7 kg, 29 wt. % NH₄OH) at 70° C., and heating at 70° C. for 1 hour while maintaining the pH above 8, then filtered and washed with distilled water. The wetcake filtrate is dried in a static oven at 110° C. for 12 hours in air, then calcined in air at 500° C. for 4 hours to obtain Comparative Catalyst 2. Comparative Catalyst 2 contains 21 wt. % CeO₂ and 15 wt. % ZrO₂.

### Example 3

### Laboratory Testing Procedures and Results

Powder samples of Catalysts 1A and 1B and Comparative Catalyst 2 are subjected to a thermal durability test by firing at 1000° C. for 4 hours in air. After firing, the samples are characterized for BET surface area, XRD crystalline structure and oxygen release capacity.

BET surface area results are listed in Table 1. Catalyst 1A has the highest surface area, followed by Comparative Catalyst 2 and then Catalyst 1B. The lower surface area of Catalyst 1B is attributed to lower thermal durability of boehmite compared to γ-alumina. Catalyst 1A and Comparative Catalyst 2 both utilize γ-alumina. Catalyst 1A has higher surface area, indicating the advantage of the present process for enhancing surface area.

XRD testing of the catalysts demonstrates that Catalyst 1A and Catalyst 1B show a single Ceₒ₅Zr_{0.5}O₂ crystalline phase. In contrast, Comp. Cat. 2 shows mixed cerium-zirconium phases. These results clearly demonstrate that the present process can lead to better phase homogeneity.

The oxygen release peak temperature is determined by a H₂-TPR (temperature-programmed reduction) experiment. H₂-TPR results for the catalysts all give one main peak, although a very broad peak for Comp. Cat. 2, at varying temperatures that can be assigned to the reduction of Ce (IV) to Ce (III) and the release of oxygen from Ce(IV). The results are shown in Table 1. Oxygen release from Catalysts 1A and 1B appears at a lower temperature than that of Comp. Cat. 2.

The percentage of Ce(IV) reduction to Ce(III) is determined at three temperature ranges of 100-500° C., 500-600° C. and 600-900° C. The results are shown in Table 2. The results indicate Cat. 1A has about twice the amount of Ce(IV) reduced compared to Comp. Cat. 2 in the low temperature range of 100-500° C., again evidencing that materials prepared by the present invention can release oxygen more efficiently at lower temperatures.

The ability to release oxygen more efficiently at lower temperature is a desirable characteristic for catalyst applications in environmental emission remediation.

### Example 4

### Engine Testing Procedures and Results

Comparative Catalyst 4A is a commercial three way (Pd—Rh) catalyst utilizing a Ce—Zr—Al mixed oxide that is produced by blending a commercial cerium-zirconium mixed oxide (Ce:Zr=1 molar ratio) and a commercial La-stabilized alumina (4% La₂O₃) at a0.57:1 weight ratio.

Catalyst 4B is the same as Comparative Catalyst 4A with the exception that the Ce—Zr—Al mixed oxide used in Comparative Catalyst 4A is replaced with the ceria-zirconia alumina composite oxide of Catalyst 1A.

Comparative Catalyst 4A and Catalyst 4B are tested according to the exhaust emissions Federal Test Procedure (FTP) following EPA certification procedures and tolerances.

2.3 L Engine Vehicle FTP Test:

The TWCs are aged in a gasoline engine for 100 hours with maximum temperature at 924° C. The aged catalysts (4A and 4B) are tested on a 2.3 L gasoline vehicle for tailpipe NOₓ, hydrocarbon (HC), and CO emissions during FTP cycle. The results are shown in Table 3, which shows the percentage decrease in emissions when Catalyst 4B is used compared to Comp. Cat. 4A.

3.5 L Engine Vehicle FTP Testing:

The TWCs are aged in a gasoline engine for 100 hours with maximum temperature at 877° C. The aged catalysts (4A and 4B) are tested on a 3.5 L gasoline vehicle for tailpipe NO_{R}, HC, and CO emissions during FTP cycle. The results are shown in Table 3, which shows the percentage decrease in emissions when using Catalyst 4B compared to Comp. Cat. 4A.

The engine testing results show a significant decrease in NO_{R}, CO and hydrocarbon emissions for a three-way catalyst system that utilizes the ceria-zirconia alumina composite oxide of the invention.

TABLE 1
Testing Results

| Catalyst | BET S.A. (m²/g) | Peak Temp in H₂-TPR (° C.)¹ |
|---|---|---|
| 1A | 95 | 455 |
| 1B | 73 | 508 |
| 2* | 83 | 540 |

*Comparative Example
¹1000° C./4 hrs in air

TABLE 2
Cerium Reduction (IV to III) over Three Temperature Ranges

| Temperature | | | |
|---|---|---|---|
| Range (° C.) | Cat. 1A | Cat. 1B | Comp. Cat. 2* |
| 100-500 | 48.4% | 27.7% | 23.7% |
| 500-600 | 19.9% | 40.3% | 36.1% |
| 600-900 | 31.8% | 29.2% | 40.3% |

*Comparative Example

TABLE 3
Emission Reduction using Catalyst 4B compared
to Comparative Catalyst 4A

| | NOₓ Reduction | CO Reduction | NMHC¹ |
|---|---|---|---|
| Engine | (%) | (%) | Reduction (%) |
| 2.3 L | 2 | 15 | 12 |
| 3.5 L | 5 | 24 | 29 |

¹NMHC = non-methane hydrocarbons

We claim:

1. A process for producing a ceria-zirconia-alumina composite oxide, said process comprising:
(a) combining a cerium (IV) compound and a zirconium (IV) compound with a slurry of aluminum oxide at a temperature greater than 40° C. to produce a reaction slurry;
(b) contacting the reaction slurry with a precipitating agent to precipitate insoluble cerium and zirconium compounds onto the aluminum oxide and form cerium-zirconium-aluminum oxide particles; and
(c) calcining the cerium-zirconium-aluminum oxide particles to produce a ceria-zirconia-alumina composite oxide.

2. The process of claim 1 wherein the temperature is within the range of 60 to 100° C.

3. The process of claim 1 wherein the cerium (IV) compound is selected from the group consisting of cerium nitrates, cerium ammonium nitrates, cerium sulfates, cerium ammonium sulfates, cerium alkoxides, and mixtures thereof.

4. The process of claim 1 wherein the zirconium (IV) compound is selected from the group consisting of zirconium carboxylates, zirconium halides, zirconium oxyhalides, zirconium carbonates, zirconium nitrates, zirconium oxynitrate, zirconium sulfates, and mixtures thereof.

5. The process of claim 1 wherein the aluminum oxide has an average particle size of greater than 1 micron.

6. The process of claim 1 wherein the aluminum oxide is a rare earth or alkaline earth-stabilized aluminum oxide.

7. The process of claim 6 wherein the rare earth or alkaline earth-stabilized aluminum oxide comprises from 0.1 to 20 weight percent rare earth or alkaline earth metal.

8. The process of claim 6 wherein the rare earth or alkaline earth-stabilized aluminum oxide contains a rare earth or alkaline earth metal selected from the group consisting of lanthanum, neodymium, praseodymium, yttrium, barium, and strontium.

9. The process of claim 1 wherein a rare earth or transition metal compound is combined with the cerium (IV) compound, the zirconium (IV) compound, and the slurry of aluminum oxide to produce the reaction slurry.

10. The process of claim 9 wherein the reaction slurry has a molar ratio of rare earth or transition metal:cerium and zirconium ranging from 0.001 to 10.

11. The process of claim 1 wherein the precipitating agent is selected from the group consisting of alkali and alkaline earth metal carbonates, ammonium and alkylammonium carbonates, ammonium and alkylammonium hydroxides, alkali and alkaline earth metal hydroxides, water-soluble organic base compounds, and mixtures thereof.

12. The process of claim 1 wherein the cerium-zirconium-aluminum oxide particles are subjected to one or more steps selected from the group consisting of filtration, washing, and spray-drying prior to calcination step (c).

13. The process of claim 1 wherein the calcination step (c) is conducted at a temperature between 400 to 1000° C.

14. A ceria-zirconia-alumina composite oxide produced by the process of claim 1.

15. A three-way catalyst comprising one or more platinum group metals and a ceria-zirconia-alumina composite oxide produced by the process of claim 1.

16. A method for treating an exhaust gas from an internal combustion engine comprising contacting the exhaust gas with a three-way catalyst of claim 15.
